(19) United States
(12) Patent Application Publication
(10) Pub. No.: US 2007/0036233 A1
(43) Pub. Date: Feb. 15, 2007

(54) Sampling of data streams and supporting methods and apparatus

(76) Inventors: Xiaoyong Yu, Grayslake, IL (US); Michael N. Kloos, Belvidere, IL (US)

Correspondence Address: MOTOROLA, INC., 1303 EAST ALGONQUIN ROAD, IL01/3RD, SCHAUMBURG, IL, 60196, US

(21) Appl. No.: 11/204,140

(22) Filed: Aug. 15, 2005

(51) Int. Cl. H04K 1/10; H04L 27/28

(52) U.S. Cl. 375/260

(57) ABSTRACT

In the present sampling technique of a transmitted data stream, a data stream is divided (318, 504) into a predefined number of sample streams to provide a plurality of sample streams, and for at least two of these sample streams, a metric value is assessed (324, 514, 516) and compared (328, 518) to provide a selected sample stream that is likely to resemble transmitted tones as represented by the data stream. The selected sample stream is then accordingly provided (330, 520) for output.

### TECHNICAL FIELD

This invention relates generally to sampling of data streams.

### BACKGROUND

It is well-known that the timing issue is less critical in Orthogonal Frequency Division Multiplexing (OFDM) than with single carrier Quadrature Amplitude Modulation (QAM), since the symbol interval in OFDM is N times that in a single carrier, where N denotes the number of tones in OFDM. Also, it is widely believed that the impact of a timing error in OFDM is phase rotation, which is purportedly easily corrected by a 1-tap frequency domain equalizer. In practice, though, when the transmitted signal is generated by an Inverse Fast Fourier Transform (IFFT), followed by upsampling, this is true only for those tones that are far away from the spectrum edge. Tones which are at the spectrum edge, or close to the spectrum edge, incur a magnitude distortion when the receiver sample timing does not precisely coincide with the sample timing at the transmitter. Theoretically, any timing offset within half CP only results in phase rotation if the OFDM signal is generated in continuous time waveform. If the transmitted waveform is taken from the IFFT and fed into a Digital-to-Analog Converter (DAC) without upsampling, a timing offset at the receiver does not induce the distortion. However, if the output of the IFFT is then upsampled prior to being run through the DAC, the distortion of the tones at or near the edge of the spectrum will occur. Substantially all OFDM signals are, however, generated by N-point Inverse Fast Fourier Transform (IFFT) and transformed to continuous time waveforms by data up-sampling and a Digital-to-Analog Converter (DAC). At the receiver, before the Fast Fourier Transform (FFT) processor, the continuous time waveform is sampled by an Analog-to-Digital Converter (ADC) and down-converted to 1× rate that is the same as the IFFT output.

Since most current systems typically use this timing error in fraction of 1× sample, this sampling offset results in phase rotation and magnitude scaling for each tone, especially tones close to the spectrum edge. As a result, the edge tones of the OFDM are usually not used for data transmission. To increase system capacity, on the other hand, it may be desired to use those abandoned tones close to the spectrum edge, since, in most cases, these phase rotations and magnitude scaling caused by a fractional sample timing error can be compensated by the 1-tap equalizer at the price of noise enhancement. If the timing error of these edge tones is not corrected, some sub-carriers (e.g., edge tones) will suffer signal-to-noise ratio loss, consequently resulting in degradation in performance.

### BRIEF DESCRIPTION OF THE DRAWINGS

The above needs are at least partially met through provision of a sampling technique described in the following detailed description, particularly when studied in conjunction with the drawings, wherein:

FIG. 1 comprises a block diagram depiction of an apparatus according to prior art;

FIG. 2 comprises a block diagram depiction of an apparatus according to an embodiment;

FIG. 3 comprises a flow chart diagram of a sampling process for the apparatus shown in FIG. 2 according to an embodiment;

FIG. 4 comprises a block diagram depiction of an apparatus according to an embodiment;

FIG. 5 comprises a flow chart diagram of a sampling process for the apparatus shown in FIG. 4 according to an embodiment;

FIG. 6 comprises a flow chart diagram of a subroutine process for providing a selected upper user tone from FIG. 5; and

FIG. 7 comprises a flow chart diagram of a subroutine process for providing a selected lower user tone from FIG. 5.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION

Generally speaking, pursuant to these various embodiments, a data stream is divided into a predefined number of sample streams to provide a plurality of sample streams, and for at least two of the sample streams, a metric value is assessed and compared to provide a selected sample stream that is likely to resemble transmitted tones as represented by the data stream. The selected sample stream is then accordingly provided for output. According to an embodiment, substantially all tones of the data stream are used by a single user. In contrast, in another embodiment, substantially all tones of the data stream are used by a plurality of users such that each user uses a plurality of tones that are specifically assigned to the user.

In one specific embodiment, prior to the data stream being divided into a plurality of sample streams, a user tone of the data stream used by a selected user that is substantially closest to a band-edge of a magnitude curve of substantially all available tones of the data stream is selected to provide a selected user tone. According to an embodiment, this selected user tone is specifically selected by assessing a first and last tone used by the selected user to provide respectively the first and last user tones. A distance between the first user tone and a first tone of substantially all available tones of the data stream is assessed to provide a first user distance, and similarly, a distance between the last user tone and a last tone of substantially all available tones of the data stream is assessed to provide a last user distance. A comparison is then done to determine whether the first user distance corresponds at least in a predetermined way to the last user distance, and if so, the first user tone is selected as the selected user tone. Otherwise, when the first user distance does not correspond to the last user distance in the predetermined way, the last user tone is selected as the selected user tone.

According to an embodiment, the plurality of sample streams is specifically divided into an upper and a lower sample stream, and a FFT is computed for both the upper and the lower sample streams. In a specific embodiment, the metric value is assessed by selecting an upper user tone and a lower user tone respectively from the upper and lower sample streams, wherein both the upper user tone and the lower user tone are each substantially closest to a band-edge of a magnitude curve of substantially all available tones of the data stream. Accordingly, a magnitude of the upper user tone and the lower user tone is computed to provide respectively an upper user metric value and a lower user metric value, which are compared to provide a maximum user metric value. The sample stream used by the selected user that corresponds to this maximum user metric value is provided as the selected sample stream for output.

In one embodiment, the selected upper user tone is obtained through an assessment of a first upper tone and a last upper tone followed by another assessment of a distance between the first and last upper user tone to a first and last tone of substantially all available tones of the data stream to provide a first upper user distance and a last upper user distance, respectively. A comparison is done to determine whether the first upper user distance corresponds at least in a predetermined way to the last upper user distance, and if so, the first upper user tone is selected as the selected upper user tone. Otherwise, when the first upper user distance does not correspond in the predetermined way to the last upper user distance, the last upper user tone is selected. Similarly, the selected lower user tone is obtained by assessing a first and last lower tone of the data stream used by the selected user to provide a first and a last lower user tone, followed by an assessment of a distance between the first and the last lower user tone to a first and last tone of substantially all available tones of the data stream to provide a first and last lower user distance. It is then determined whether the first and last lower user distance corresponds in a predetermined way to each other, and if so, the first lower user tone is selected or otherwise, the last lower user tone is selected.

According to a specific embodiment, the assessment of the metric value is done through a selection of a sample stream from the two sample streams, which is used to assess a first metric value. A next sample stream is also selected and used to assess a second metric value. The comparison of these metric values is then done to provide a maximum metric value, and the sample stream associated with the maximum metric value is selected as the selected sample stream for output. In another embodiment, the metric value comprises an absolute value of a tone of the sample stream that is substantially closest to a band-edge of a magnitude curve of substantially all available tones in the data stream and a value from a FFT of the sample stream.

According to various embodiments, an apparatus is provided, which includes a sampling divider circuit that divides a data stream into a predefined number of sample streams to provide a plurality of sample streams, a sampling timing controller circuit coupled to the sampling divider circuit that assesses a metric value for each of at least two sample streams from the plurality of sample streams to provide a selected sample stream that is likely to resemble transmitted tones of the data stream, and a switch circuit coupled to the sampling timing controller circuit that provides the selected sample stream from the sampling timing controller circuit for output. In one embodiment, the sampling divider circuit further selects a user tone of the data stream used by a selected user that is substantially closest to a band-edge of a magnitude curve of substantially all available tones of the data stream to provide a selected user tone, wherein the selected sample stream is obtained from the selected user tone. The sampling divider circuit also further divides the data stream into an upper sample stream and a lower sample stream and computes a Fast Fourier Transform for the upper sample stream and the lower sample stream, according to an embodiment.

The sampling timing controller circuit, for a specific embodiment, further selects an upper and lower user tone from the upper and lower sample streams used by a selected user to provide a selected upper and lower user tone, wherein the upper and lower user tone is substantially closest to a band-edge of a magnitude curve of substantially all available tones of the data stream. In particular, the sampling timing controller circuit further computes a magnitude of the selected upper and lower user tones to provide an upper user metric value and a lower user metric value for comparison to provide a maximum user metric value, wherein the selected sample stream is associated with the maximum user metric value. According to an embodiment, the sampling timing controller circuit further compares the metric values of the at least two sample streams to provide a maximum metric value, wherein the selected sample stream is associated with the maximum user metric value. The metric value, in one embodiment, may include an absolute value of a tone of the sample stream that is substantially closest to a band-edge of a magnitude curve of substantially all available tones in the data stream and/or a value from a FFT of the sample stream.

The various embodiments also provide another apparatus that includes a sampling divider circuit that divides a data stream into a predefined number of sample streams to provide a plurality of sample streams, a sampling timing controller circuit coupled to the sampling divider circuit that assesses a metric value for each at least two sample stream from the plurality of sample streams to provide a first metric value and a second metric value and compares the first metric value and the second metric value to provide a maximum metric value, and a switch circuit coupled to the sampling timing controller circuit that provides a sample stream associated to the maximum metric value from the sampling timing controller circuit for output. Another apparatus is further provided, which includes a sampling divider circuit that divides a data stream into an upper sample stream and a lower sample stream, an upper Fast Fourier Transform circuit coupled to the sampling divider circuit that computes a Fast Fourier Transform for the upper sample stream, a lower Fast Fourier Transform circuit coupled to the sampling divider circuit that computes a Fast Fourier Transform for the lower sample stream, a sampling timing controller circuit coupled to the sampling divider circuit that selects an upper and a lower user tone from the upper and lower sample streams used by a selected user to provide a selected upper and lower user tone such that the upper and lower user tone is substantially closest to a band-edge of a magnitude curve of substantially all available tones of the data stream and computes a magnitude of the selected upper and lower user tones to provide an upper user metric value and a lower user metric value for comparison to provide a maximum user metric value, and a switch circuit coupled to the sampling timing controller circuit that provides a sample stream associated with the maximum user metric value from the sampling timing controller circuit for output.

Through these various teachings, a novel sampling technique has been provided that, among other things, provides for simple computation, while providing for a robust error timing value in cases of noise channel since the noise is effectively averaged out. With the various embodiments described, the worst sampling timing case is effectively only a quarter sample offset, where a 1-tap equalizer can compensate the phase rotation and magnitude scaling with only tolerable performance degradation for edge tones. Overall, the various teachings significantly improve performance for the edge tones, while virtually without experiencing any sampling timing degradation. Thus, the sampling technique provided with the various teachings translates to a simple and effective process for the timing error correction, resulting in improved noise-to-signal ratio in the communications system.

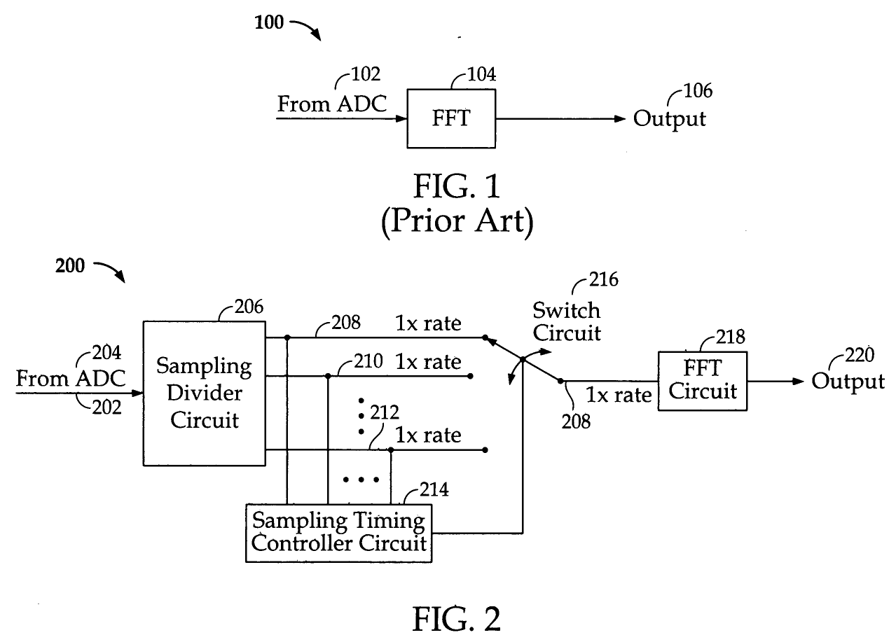

Referring now to the drawings, and in particular to FIG. 1, a block diagram depiction of an apparatus according to prior art is shown and indicated generally at numeral reference 100. In particular, FIG. 1 shows an apparatus with FFT processing with a timing error of 1× sampling. As typically done in the prior art, a data stream coming from the ADC 102 is processed through a FFT 104 that outputs 106 a FFT of the data stream for post FFT processing.

Turning now to FIG. 2, for purposes of providing an illustrative but non-exhaustive example to facilitate this description, a block diagram depiction of an apparatus according to one embodiment is shown and indicated generally at 200. Those skilled in the art, however, will recognize and appreciate that the specifics of this illustrative example are not specifics of the invention itself and that the teachings set forth herein are applicable in a variety of alternative embodiments. In particular, please note that as readily appreciated by one skilled in the art, the circuits and the arrangement of these circuits shown are only given as one of many configurations and circuitry topologies available, and these various alternative embodiments, although not shown, are readily appreciated by a skilled artisan. Thus, they are within the scope of the various teachings described. Moreover, since the apparatus shown is a partial view of circuitry topology of an apparatus, the apparatus 200 shown does not necessarily include all of the components required of a typical radio base station. As such, it should be understood that the various teachings may include other circuit components that may not be shown but are well known to one skilled in the art. Moreover, “circuit” refers to one or more component devices such as, but not limited to, processors, memory devices, application specific integrated circuits (ASICs), and/or firmware, which are created to implement or adapted to implement (perhaps through the use of software) certain functionality, all within the scope of the various teachings described.

In this embodiment, a data stream 202 coming from an ADC 204 is processed through a sampling divider circuit 206 circuit that divides the data stream into a predefined number of sample streams to provide a plurality of sample streams 208, 210, 212. A sampling timing controller circuit 214, which is coupled to the sampling divider circuit 206, assesses a metric value for each of at least two ample streams and compares the metric values in order to provide a selected sample stream 208 (e.g., in this example shown) that is likely to resemble the transmitted tones of the data stream. A switch circuit 216 is coupled to the sampling timing controller circuit 214 that provides the selected sample stream 208 to a FFT circuit 218, which provides a FFT output 220 of the selected sample stream.

According to an embodiment, the sampling divider circuit 206 further selects a user tone of the data stream used by a selected user that is substantially closest to a band-edge of a magnitude curve of substantially all available tones of the data stream, and the selected sample stream is obtained from this selected user tone. In one embodiment, the sampling timing controller circuit 214 further compares the metric values from the at least two sample streams to provide a maximum metric value, which is used to select the sample stream for output. The metric value may be an absolute value of a tone of the sample stream that is substantially closest to a band-edge of a magnitude curve of substantially all available tone in the data stream according to this embodiment shown.

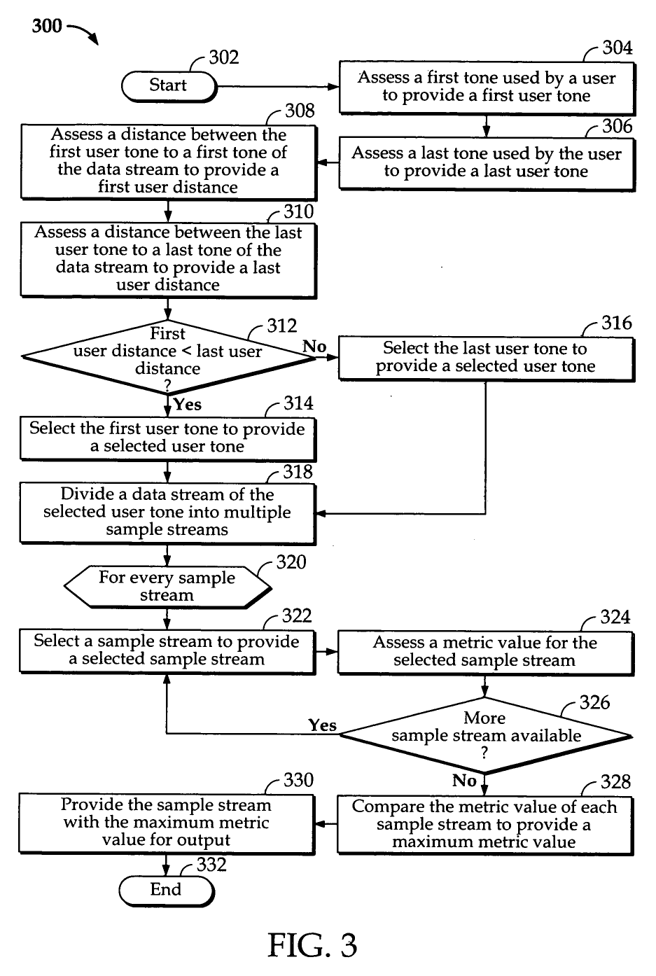

Turning now to FIG. 3, a flow chart diagram illustrating a sampling process for the apparatus shown in FIG. 2 according to an embodiment is shown and indicated generally at numeral reference 300. Although the process 300 corresponds to the embodiment shown in FIG. 2, as described previously, since the circuitry of the transmitter can be altered, other processes to implement the different circuitry of the transmitter are readily appreciated by one skilled in the art. Thus, other processes and/or slight alternation of the process 300 are contemplated, and they are within the teachings of the various embodiments in the invention. For the embodiment shown, substantially all of the ones of the data stream are used by a single user.

In this particular embodiment, to select a user tone of the data stream used by a selected user that is closest to a band-edge of the system tones (e.g., a magnitude curve of substantially all available tones of the data stream), an assessment 304, 306 of a first and last tone used by the selected user is made to provide a first and last user tone, respectively. For the first user tone, a distance between the first user tone and the first tone of the data stream is assessed 308 to provide a first user distance. Similarly, for the last user tone, a distance between the last user tone and a last tone of the data stream is assessed 310 to provide a last user distance. The first and last user distance is compared to determine 312 whether they correspond to each other in at least a predetermined way, specifically, in this embodiment, whether the first user distance is less than the last user distance. If they do correspond in the predetermined way to each other, specifically if the first user distance is less than the last user distance, the first user tone is selected 314 to provide the selected user tone, or otherwise, the last user tone is selected 316 for the selected user tone.

After a selected user tone that is closest to the band-edge of all the tones of the data stream, the data stream of the selected user tone is divided 318 into multiple sample streams, specifically 1 through N. For at least two of the sample streams, although every sample stream 320 is preferred for this embodiment shown, a sample stream is selected 322 to provide a selected sample stream in which a metric value of the selected sample stream is assessed 324. It is then determine 326 whether there are more sample streams available. In other words, all the sample streams are preferably processed until there is a metric value for every sample stream. If there are more sample streams that are available, the process 300 loops back to select 322 another sample stream. If, however, all the sample streams have been accounted for, the metric values of each of the sample streams are compared 328 to provide a selected sample stream that is likely to resemble the transmitted tones as are represented by the data stream.

Specifically, in this embodiment shown, a maximum of the metric values is selected as the maximum metric value, and the sample steam associated with the maximum metric value is outputted 330, which ends 332 the process 300 at this point. Specifically since the FFT is computed after an optimized sample stream has been selected, a mathematical formula is used to compute the metric value, which is shown below:

$${metric}_{K} = \vert {\sum }_{n = 0}^{N - 1} {y}_{n} {ⅇ}^{- j2π ( \frac{nK}{N} )} \vert \qquad ( 1 )$$

such that metric_{K} is the metric value of a tone with index K that is closest to a band-edge of the data stream and yₙ is a tone of index n. Other metric values may be more suitable, but a proper defined metric value greatly depends upon the communications system that the various embodiments are to be implemented. As such, this metric value is shown as one of multiple metric values to be used in order to select a sample stream associated with this metric value that is likely to resemble transmitted tones as are represented by the data stream. Because the appropriate metric value is readily appreciated by a skilled artisan, other metric values, although not specifically shown, are within the scope of various teachings provided.

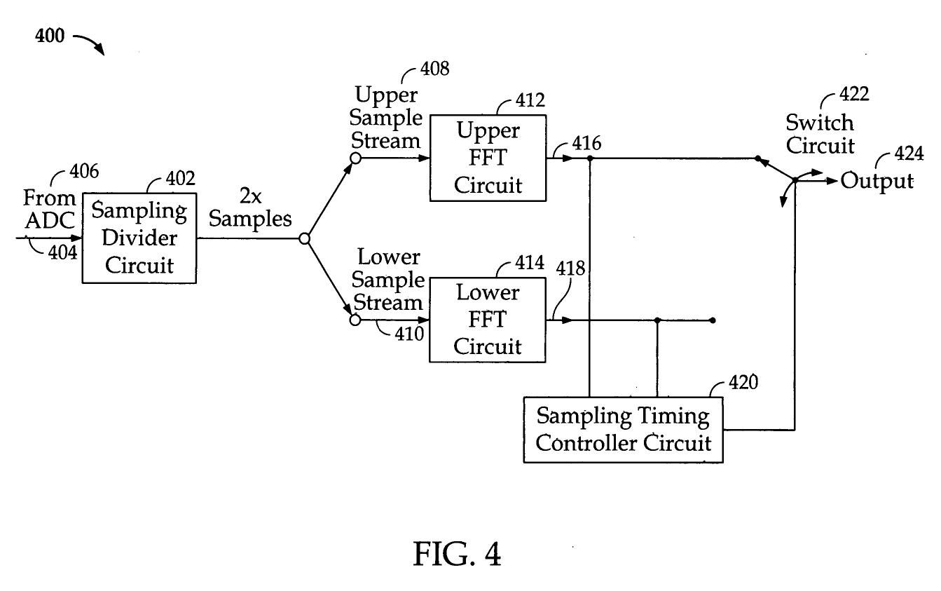

Referring now to FIG. 4, a block diagram depiction of an apparatus according to one embodiment is shown and indicated generally at numeral reference 400. This particular embodiment is preferably, although not specifically limited to, implemented into a communications system where substantially all of the tones of the data stream are used by a plurality of users, wherein each user uses a plurality of tones of that are specifically assigned to the user. A sampling divider circuit 402 divides a data stream 404 from a ADC 406 into two-times sampling timing, specifically an upper sample stream 408 and a lower sample stream 410. Each of the upper and lower sample streams 408, 410 is feed into an upper and a lower FFT circuit 412, 414 that outputs a FFT for each of the streams, specifically an upper FFT 416 and a lower FFT 418, to a sampling timing controller circuit 420, which obtains a metric value from the FFT 416, 418 of the upper and lower sample 408, 410.

Specifically, according to an embodiment, the sampling timing controller circuit 420 selects an upper and a lower user tone from the upper and lower sample stream used by a user that is substantially closest to the band-edge. A magnitude of these selected upper and lower user tones is computed to provide an upper and a lower user metric value, respectively. The sampling timing controller circuit 420 then compares the upper user metric value and the lower user metric value to provide a maximum user metric value, and the sample stream with this maximum metric value is provided by a switch circuit 422 for output 424. In this embodiment shown, the metric value is based a value from the FFT of the sample streams.

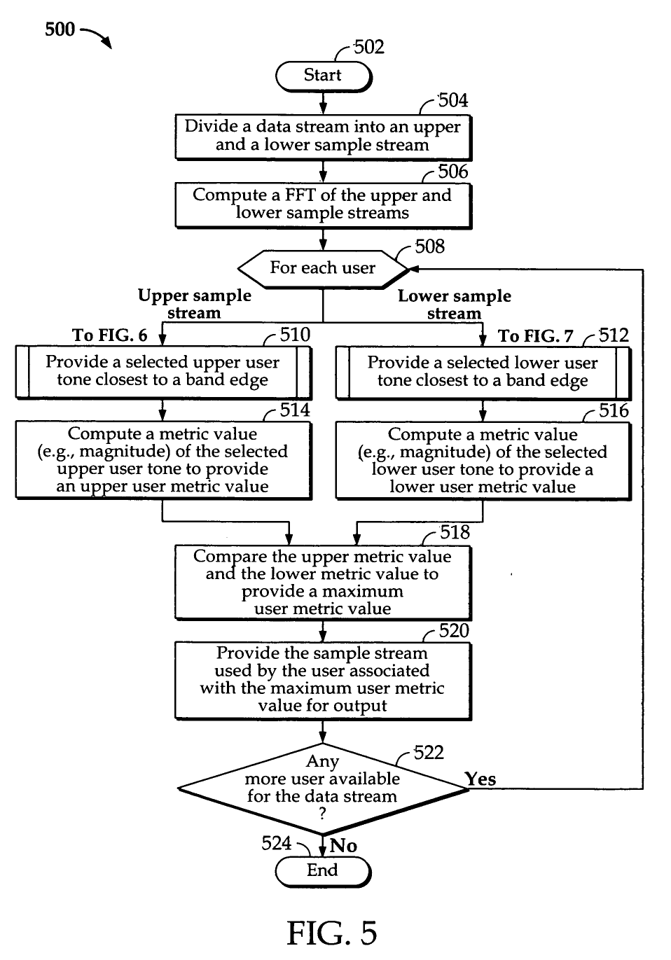

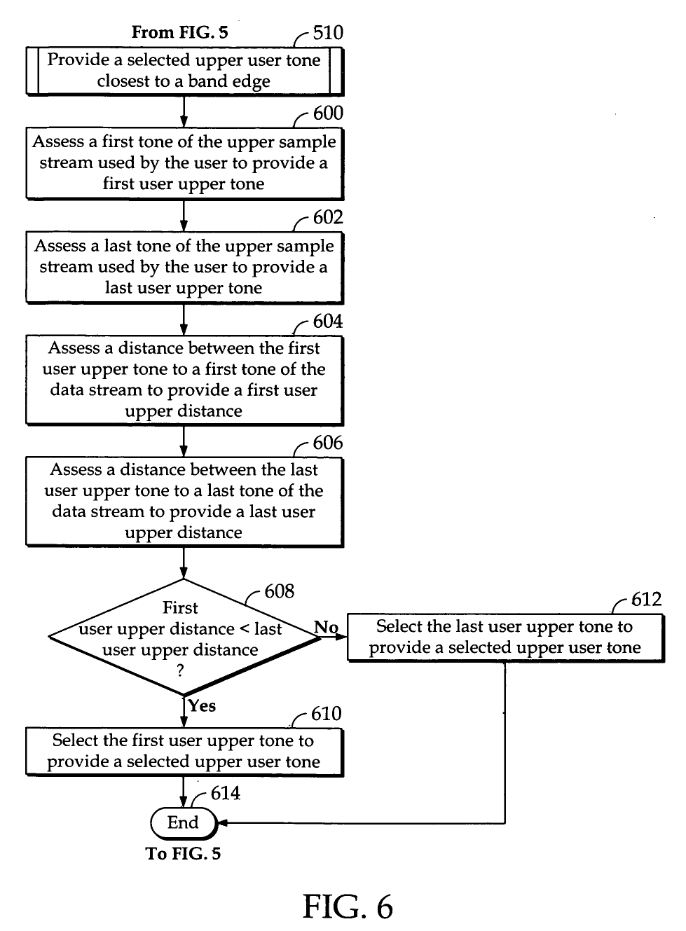

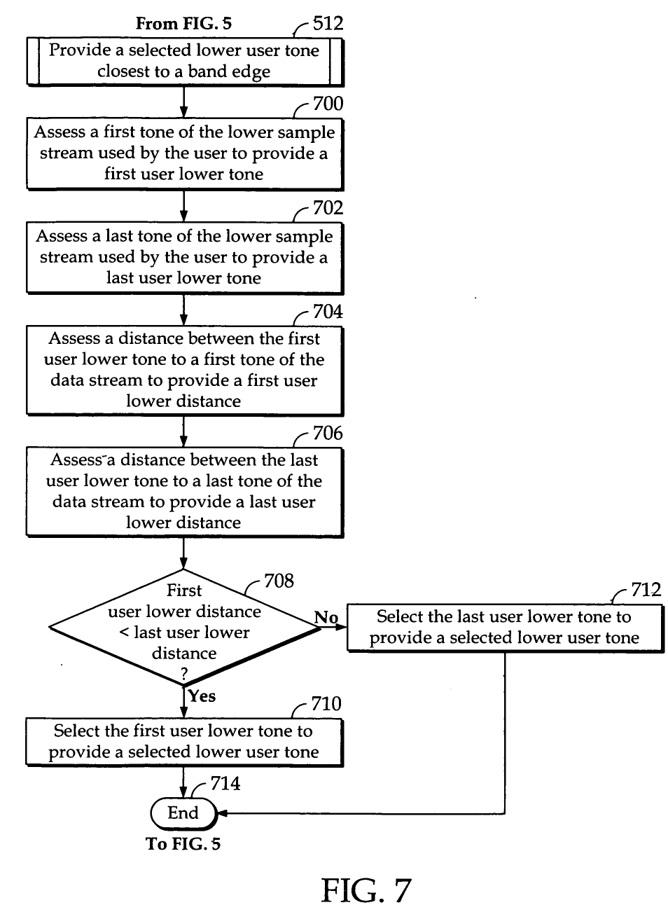

Turning to FIG. 5, a flow chart diagram of a sampling process for the apparatus shown in FIG. 4 according to an embodiment is shown and indicated generally at numeral reference 500. The sampling process 400 starts 502 by dividing 504 the data stream into an upper and a lower sample stream, and for each of the sample streams, a FFT is computed. Since the embodiment assumes multiple users using all the tones from the data stream, an iteration is run for each user 508, as shown. In particular, for each user 508, a subroutine process 510, 512 (shown in FIGS. 6 and 7) is executed to provide a selected upper and lower user tone that is closest to the band-edge of all tones included in the data stream, and a metric value of the selected upper and lower user tone is then computed 514, 516 to provide an upper and a lower user metric value, which are compared 518 to provide a maximum user metric value. In other word, the upper and the lower user metric value are compared 518 to find a maximum value that is used as the maximum user metric value. The sample stream used by the user that is associated with this maximum metric value is then provided 520 for output. To account for every user using the tones of the data stream, it is next determined 522 whether there are any more user available for the data stream, and if so, the sampling process 500 loops back to select another user 508. Otherwise, when all the users have been accounted for, specifically there are no more users available, the process 500 ends 524 at this point.

Referring now to FIG. 6, a flow chart diagram of a subroutine process 510 for providing a selected upper user tone that is closest to the band-edge from FIG. 5 is shown. The subroutine process 510 starts with an assessment 600, 602 of a first and a last tone of the upper sample stream that is used by the user to provide a first and last user upper tone, respectively. Using the first user upper tone, a distance between this first user upper tone and a first tone of the data stream is then assessed 604 to provide a first user upper distance. Similarly, another assessment 606 of a distance between the last user upper tone and a last tone of the data stream is made to provide a last user upper distance. The first user upper distance is compared with the last user upper distance to determine 608 whether they correspond at least in a predetermined way to each other, specifically whether the first user upper distance is less than the last user upper distance in this embodiment shown. If the first user upper distance is, in fact, less than the last user upper distance, the first user upper tone is selected 610 to provide the selected upper user tone, or otherwise, the last user upper tone is selected 612 instead. The process ends 614 and returns to FIG. 5.

FIG. 7 similarly shows the flow chart diagram of the subroutine process 512 for providing the selected lower user tone from FIG. 5, instead of the selected upper user tone. Specifically, similar first and last tone of the lower sample stream that is used by the user is assessed 700, 702 to provide a first and last user lower tone. A distance between the first user lower tone and a first tone of the data stream is assessed 704 to provide a first user lower distance, and a distance between the last user lower tone and a last tone of the data stream is assessed 706 to provide a last user lower distance. A comparison is made to determine 708 whether the first user lower distance corresponds in at least a predetermined way to (e.g., whether it is less than in this embodiment shown) the last user lower distance, and if so, the first user lower tone is selected 710 to provide the selected lower user tone, or otherwise, the last user lower tone is selected 712. The process again ends 714 and returns to FIG. 5.

With these various teachings shown, a novel sampling technique has been provided that, among other things, provides for a simple timing computation, while providing a robust error timing value in cases of noisy channels since the noise is effectively averaged out with the value provided. The worst sampling timing case, with the various embodiments described, is effectively only a quarter sample offset, where 1-tap equalizer can compensate the phase rotation and magnitude scaling with some tolerable performance degradation for edge tones. Overall, the various teachings significantly improve performance of the edge tones, while experiencing minimal sampling timing degradation. Thus, the sampling technique provided with the various teachings translates into a simple and effective process for the timing error correction, which can result in an improved noise-to-signal ratio in the communications system.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method comprising:
dividing a data stream into a predefined number of sample streams to provide a plurality of sample streams;
assessing a metric value for each of at least two sample streams from the plurality of sample streams;
comparing the metric values of the at least two of the sample streams to provide a selected sample stream that is likely to resemble transmitted tones as represented by the data stream;
providing the selected sample stream for output.

2. The method according to claim 1 further comprising, prior to dividing a data stream into a predefined number of sample streams to provide a plurality of sample streams:
selecting a user tone of the data stream used by a selected user that is substantially closest to a band-edge of a magnitude curve of substantially all available tones of the data stream to provide a selected user tone.

3. The method according to claim 2, wherein selecting a user tone of the data stream used by a selected user that is substantially closest to a band-edge of the magnitude curve of substantially all available system tones further comprises:
assessing a first tone of the data stream used by the selected user to provide a first user tone;
assessing a last tone used by the selected user to provide a last user tone;
assessing a distance between the first user tone to a first tone of substantially all available tones of the data stream to provide a first user distance;
assessing a distance between the last user tone to a last tone of substantially all available tones of the data stream to provide a last user distance;
determining whether the first user distance corresponds in a predetermined way to the last user distance;
selecting the first user tone as the selected user tone when the first user distance corresponds in the predetermined way to the last user distance;
selecting the last user tone as the selected user tone when the first user distance does not correspond in the predetermined way to the last user distance.

4. The method according to claim 1, wherein substantially all of the tones of the data stream are used by a single user.

5. The method according to claim 1, wherein substantially all of the tones of the data stream are used by a plurality of users, wherein each user uses a plurality of tones that are specifically assigned to the user.

6. The method according to claim 1, wherein dividing a data stream into a predefined number of sample streams to provide a plurality of sample streams further comprises:
dividing the data stream into an upper sample stream and a lower sample stream;
computing a Fast Fourier Transform for the upper sample stream;
computing a Fast Fourier Transform for the lower sample stream.

7. The method according to claim 6, wherein assessing a metric value for each of at least two sample streams from the plurality of sample streams further comprises:
selecting an upper user tone from the upper sample stream used by a selected user to provide a selected upper user tone, wherein the upper user tone is substantially closest to a band-edge of a magnitude curve of substantially all available tones of the data stream;
selecting a lower user tone from the lower sample stream used by the selected user to provide a selected lower user tone, wherein the lower user tone is substantially closest to a band-edge of a magnitude curve of substantially all available tones of the data stream;
computing a magnitude of the upper user tone to provide an upper user metric value;
computing a magnitude of the lower user tone to provide a lower user metric value;
comparing the upper user metric value and the lower user metric value to provide a maximum user metric value;
providing the sample stream used by the selected user related to the maximum user metric value as the selected sample stream for output.

8. The method according to claim 7, wherein selecting an upper user tone from the upper sample stream used by a selected user to provide a selected upper user tone further comprises:
assessing a first upper tone of the data stream used by the selected user to provide a first upper user tone;
assessing a last upper tone used by the selected user to provide a last upper user tone;
assessing a distance between the first upper user tone to a first tone of substantially all available tones of the data stream to provide a first upper user distance;
assessing a distance between the last upper user tone to a last tone of substantially all available tones of the data stream to provide a last upper user distance;
determining whether the first upper user distance corresponds in a predetermined way to the last upper user distance;
selecting the first upper user tone as the selected upper user tone when the first upper user distance corresponds in the predetermined way to the last upper user distance;
selecting the last upper user tone as the selected upper user tone when the first upper user distance does not correspond in the predetermined way to the last upper user distance.

9. The method according to claim 7, wherein selecting a lower user tone from the lower sample stream used by a selected user to provide a selected lower user tone further comprises:
assessing a first lower tone of the data stream used by the selected user to provide a first lower user tone;
assessing a last lower tone used by the selected user to provide a last lower user tone;
assessing a distance between the first lower user tone to a first tone of substantially all available tones of the data stream to provide a first lower user distance;
assessing a distance between the last lower user tone to a last tone of substantially all available tones of the data stream to provide a last lower user distance;
determining whether the first lower user distance corresponds in a predetermined way to the last lower user distance;
selecting the first lower user tone as the selected lower user tone when the first lower user distance corresponds in the predetermined way to the last lower user distance;
selecting the last lower user tone as the selected lower user tone when the first lower user distance does not correspond in the predetermined way to the last lower user distance.

10. The method according to claim 1 further comprising:
wherein assessing a metric value for each of at least two sample streams from the plurality of sample streams comprises:
selecting a sample stream from the at least two of the plurality of sample streams to provide a first sample stream;
assessing a first metric value of the first sample stream;
selecting a next sample stream from the at least two of the plurality of sample streams to provide a second sample stream;
assessing a second metric value of the second sample stream;
wherein comparing the metric values of the at least two of the sample streams to provide a selected sample stream that is likely to resemble transmitted tones as are represented by the data stream comprises:
comparing the first metric value and the second metric value to provide a maximum metric value, wherein a sample stream associated with the maximum metric value is the selected sample stream for output.

11. The method according to claim 1, wherein the metric value comprises any one or more selected from a group of an absolute value of a tone of the sample stream that is substantially closest to a band-edge of a magnitude curve of substantially all available tones in the data stream and a value from a Fast Fourier Transform of the sample stream.

12. An apparatus comprising:
a sampling divider circuit adapted to divide a data stream into a predefined number of sample streams to provide a plurality of sample streams;
a sampling timing controller circuit coupled to the sampling divider circuit, wherein the sampling timing controller circuit is adapted to assess a metric value for each of at least two sample streams from the plurality of sample streams and is adapted to compare the metric values of the at least two of the plurality of sample streams to provide a selected sample stream that is likely to resemble transmitted tones as represented by the data stream;
a switch circuit coupled to the sampling timing controller circuit, wherein the switch circuit is adapted to provide the selected sample stream from the sampling timing controller circuit for output.

13. The apparatus according to claim 12, wherein the sampling divider circuit is further adapted to select a user tone of the data stream used by a selected user that is substantially closest to a band-edge of a magnitude curve of substantially all available tones of the data stream to provide a selected user tone, wherein the selected sample stream is obtained from the selected user tone.

14. The apparatus according to claim 12, wherein the sampling divider circuit is further adapted to divide the data stream into an upper sample stream and a lower sample stream and to compute a Fast Fourier Transform for the upper sample stream and the lower sample stream.

15. The apparatus according to claim 14, wherein the sampling timing controller circuit is further adapted to select an upper and lower user tone from the upper and lower sample streams used by a selected user to provide a selected upper and lower user tone, wherein the upper and lower user tone is substantially closest to a band-edge of a magnitude curve of substantially all available tones of the data stream.

16. The apparatus according to claim 15, wherein the sampling timing controller circuit is further adapted to compute a magnitude of the selected upper and lower user tones to provide an upper user metric value and a lower user metric value for comparison to provide a maximum user metric value, wherein the selected sample stream is associated with the maximum user metric value.

17. The apparatus according to claim 12, wherein the sampling timing controller circuit is further adapted to compare the metric values of the at least two sample streams to provide a maximum metric value, wherein the selected sample stream is associated with the maximum user metric value.

18. The apparatus according to claim 12, wherein the metric value comprises any one or more selected from a group of an absolute value of a tone of the sample stream that is substantially closest to a band-edge of a magnitude curve of substantially all available tones in the data stream and a value from a Fast Fourier Transform of the sample stream.

19. An apparatus comprising:
a sampling divider circuit adapted to divide a data stream into a predefined number of sample streams to provide a plurality of sample streams;
a sampling timing controller circuit coupled to the sampling divider circuit, wherein the sampling timing controller circuit is adapted to assess a metric value for each at least two sample stream from the plurality of sample streams to provide a first metric value and a second metric value and is adapted to compare the first metric value and the second metric value to provide a maximum metric value;
a switch circuit coupled to the sampling timing controller circuit, wherein the switch circuit is adapted to provide a sample stream associated to the maximum metric value from the sampling timing controller circuit for output.

20. An apparatus comprising:
a sampling divider circuit adapted to divide a data stream into an upper sample stream and a lower sample stream;
an upper Fast Fourier Transform circuit coupled to the sampling divider circuit, wherein the upper Fast Fourier Transform circuit is adapted to compute a Fast Fourier Transform for the upper sample stream;
a lower Fast Fourier Transform circuit coupled to the sampling divider circuit, wherein the lower Fast Fourier Transform circuit is adapted to compute a Fast Fourier Transform for the lower sample stream;
a sampling timing controller circuit coupled to the sampling divider circuit, wherein the sampling timing controller circuit is adapted to select an upper and a lower user tone from the upper and lower sample streams used by a selected user to provide a selected upper and lower user tone such that the upper and lower user tone is substantially closest to a band-edge of a magnitude curve of substantially all available tones of the data stream and is adapted to compute a magnitude of the selected upper and lower user tones to provide an upper user metric value and an lower user metric value for comparison to provide a maximum user metric value;
a switch circuit coupled to the sampling timing controller circuit, wherein the switch circuit is adapted to provide a sample stream associated with the maximum user metric value from the sampling timing controller circuit for output.
